(19) United States
(12) Patent Application Publication
(10) Pub. No.: US 2009/0120720 A1
(43) Pub. Date: May 14, 2009

(54) Frictionless descender for abseiling along a rope

(76) Inventor: Johnny Wayne Arms, Jacksonville, AL (US)

Correspondence Address: Johnny Wayne Arms, 111 Marie Ave, Jacksonville, AL, 36265, US

(21) Appl. No.: 11/983,453

(22) Filed: Nov. 13, 2007

(51) Int. Cl. A62B 1/14

(52) U.S. Cl. 182/193; 182/191

(57) ABSTRACT

A descender comprises a base plate (20) having a point of connection (24A) to a harness and a pivoting plate (22) mounted pivotally on the base plate (20) about an axis with the pivoting plate (22) having two spaced rotating pulleys (25 and 26) for engaging a rope (39). The base plate (20) has a rotating stationary pulley (27) mounted thereon to provide opposition to rotating pulleys (25 and 26) which are mounted on the pivoting plate (22). A control handle (23) with a cam surface (41) presses against the pivoting plate (22) which increases the space between rotating pulleys (25 and 26) on the pivoting plate (22) and the stationary pulley (27) that is secured to the base plate (20), thereby relieving the clamping effect. A speed regulator (34) stops the control handle (23) from full travel, allowing less than maximum rate of descent. A door plate (21) protects the internal parts when secured closed.

### FIELD OF INVENTION

This invention relates to self-locking descenders.

### BACKGROUND

### Prior Art

Abseiling is a method of travel used for descent along a rope on steep surfaces such as cliffs or tall buildings. The reason for this activity varies from recreational purposes to rescue of persons to inspection of tall structures such as buildings, towers, or bridges.

Abseiling is accomplished by using a descender which creates a tortuous path for the support rope which is affixed to a support base at the upper end and routed through the descender. The other end of the rope is allowed to hang free as a loose end. The operator controls the rate of descent by utilizing a device included on the descender or by holding tension on the loose end of the rope.

The descender has evolved over time from very simple friction-causing devices through which the rope is wound to more complex devices which include single-lock devices such as U.S. Pat. No. 5,076,400 and double-lock devices such as U.S. Pat. No. 6,732,833 that automatically stop one's descent if one becomes unconscious or is injured to the point that one is physically incapable of operating the descender.

One common characteristic of descenders heretofore is the buildup of heat within the descender during continuous use. The heat is caused by the friction of the rope sliding against surfaces of the descender as it passes along the tortuous path configured within the descender. The friction causes excessive wear of the rope and descender which require frequent replacing. Descenders that require the squeezing action to descend such as U.S. Pat. No. 6,732,833 can cause operator fatigue due to having to hold the release open while doing long descents.

### SUMMARY

The invention described is a descender of the self-locking type for abseiling along a rope. This descender has a base plate with a means for connection to a harness. Mounted to the base plate is a pivotally-mounted plate with two freely-rotating pulleys affixed thereon. When the descender is suspended by a rope and weight is added to the connection point, the pulleys on the pivoting plate are urged into a pulley that is affixed to the base plate but freely rotates about its connection. This action is caused by the upward pull of the rope on the pulley mounted to the pivoting plate on the opposite end from the connection point of the pivoting plate. This causes a clamping of the rope between the pulleys which in turn stops all rope travel. There is a control handle with a cam surface that widens the gap between the pivoting plate and the stationary pulley when moved downward, thereby releasing the rope and allowing travel to resume. The more the control handle is moved down, the greater the rate of descent. When the handle is released, the descender locks the rope again. There is a speed regulator, when activated, that will only allow the control handle to be slightly depressed, allowing only a slow rate of descent. A door plate affixed to the base plate pivots open to install or remove the rope.

The reason for this invention is to eliminate the destructive heat and wear on the rope and descender caused by the friction of the rope sliding through the device. The pulleys with bearings accomplish this very well.

### BRIEF DESCRIPTION OF THE DRAWINGS

FIG. 1 shows the descender ready for use.

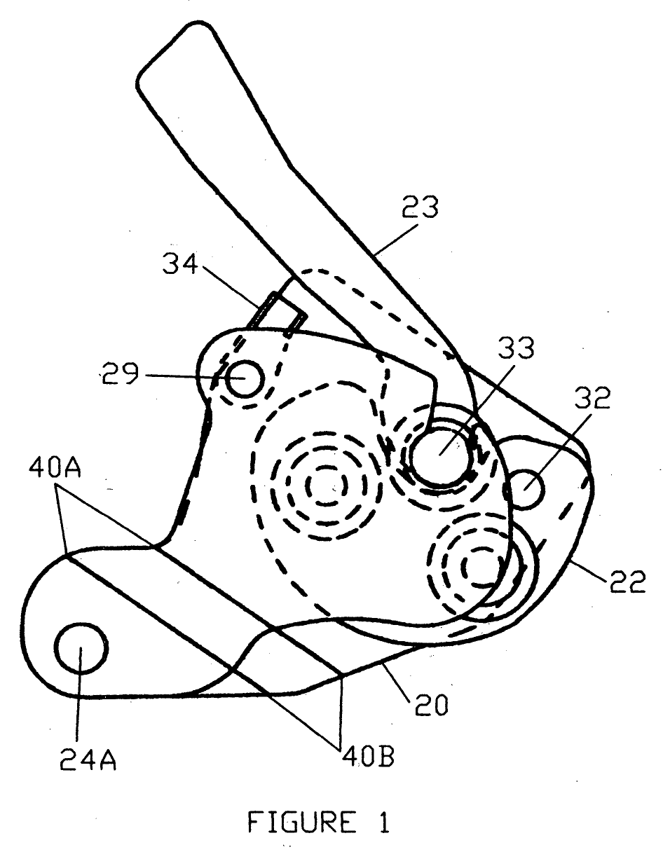

FIG. 2 shows the descender open.

FIG. 3 shows the routing of the rope through the descender.

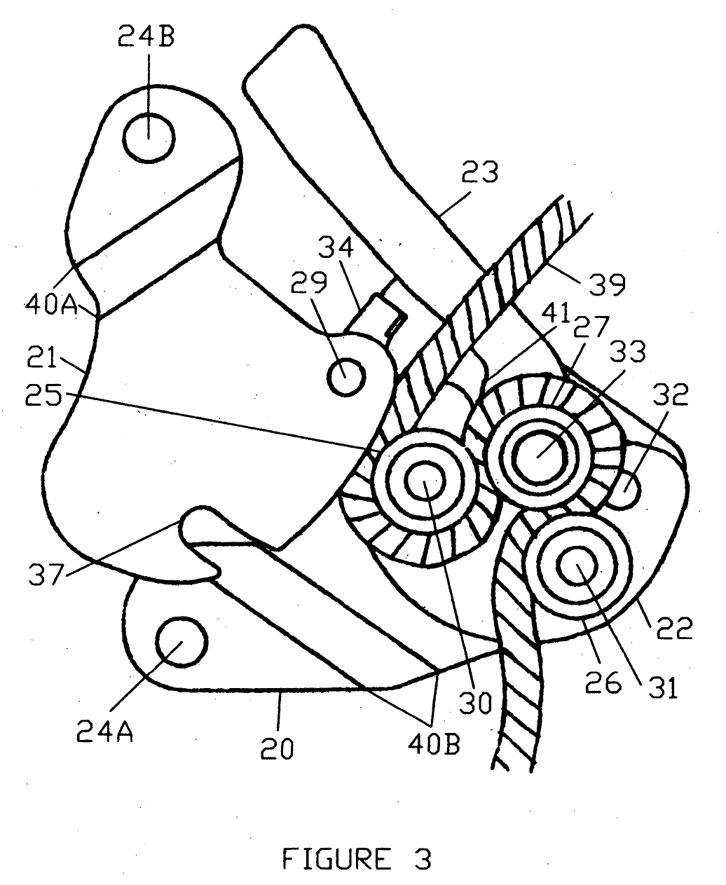

FIG. 4 shows a side view of the descender where the rope enters from above.

FIG. 5 is a side view of the door plate and base plate showing the bends required.

FIG. 6 is a plan view of the base plate showing the positions of the attached embodiments.

FIG. 7 shows the pivoting plate and arrangements of the pulleys 25 and 26.

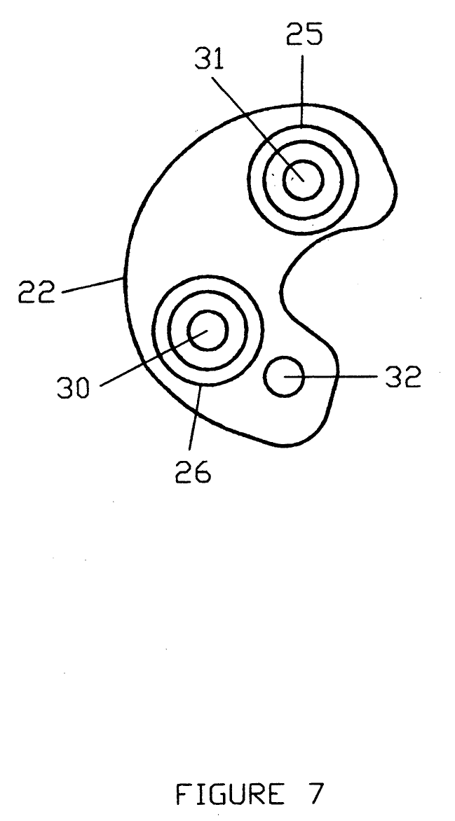

FIG. 8 is the control handle showing the cam design and the connection point.

FIG. 9 shows the pivoting plate at the end of its arc when the rope is inserted.

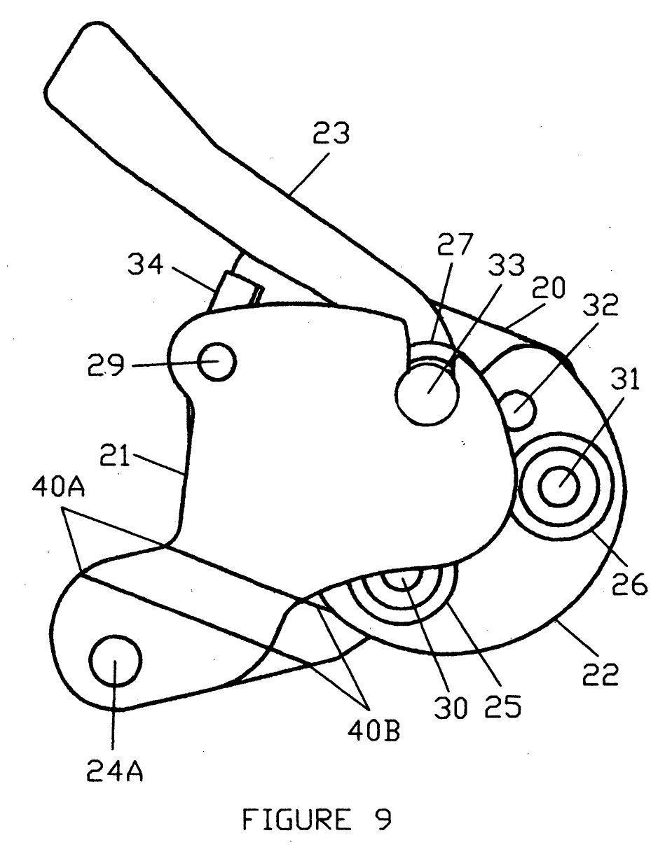

### DETAILED DESCRIPTION

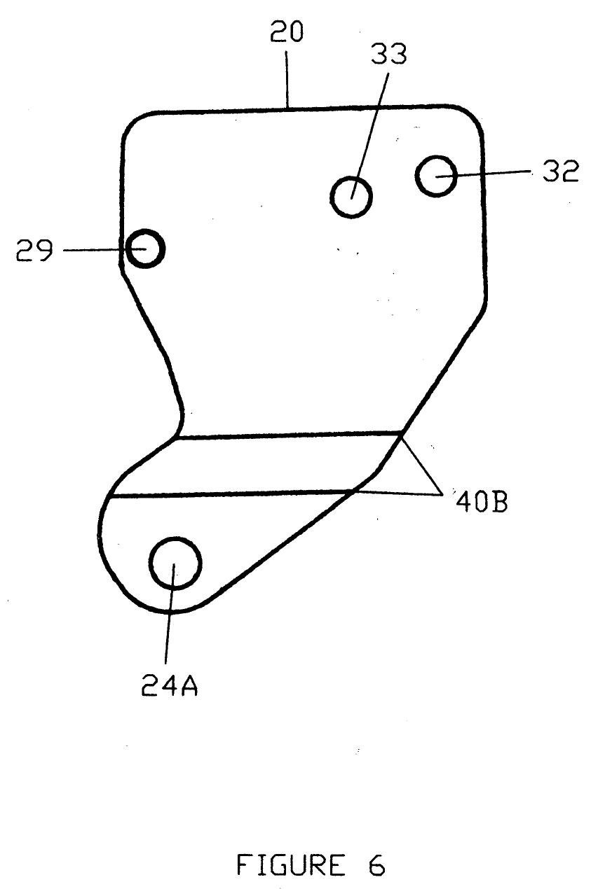

FIG. 6 shows the base plate 20 and the arrangements for stationary pulley stud 33, door stud 29, and pivoting plate stud 32. The bends 40B of base plate 20 and the connection point 24A are also indicated in FIG. 6.

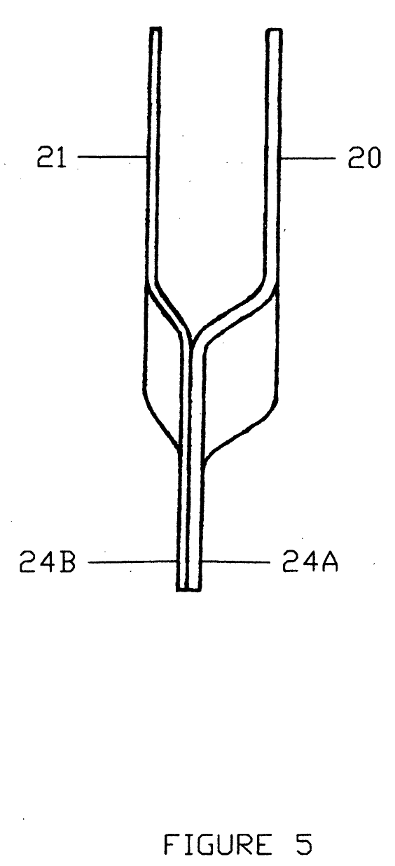

FIG. 5 shows the angles and bends required in the base plate 20 and the door plate 21 to encase the other embodiments.

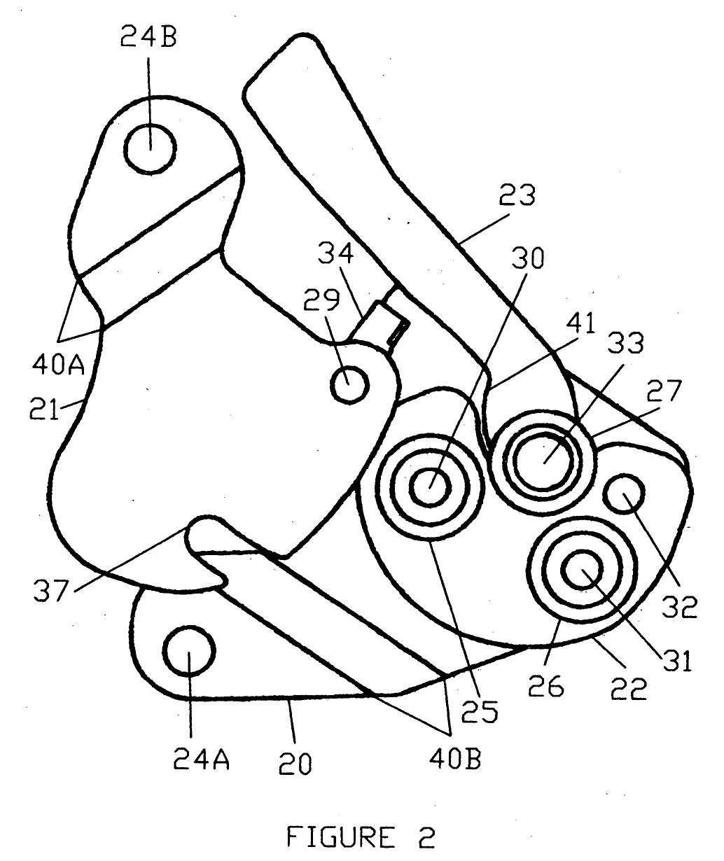

In FIG. 2, the door plate 21 is connected to the base plate 20 about a stud 29 that it rotates about to access the interior for inserting or removing the rope 39.

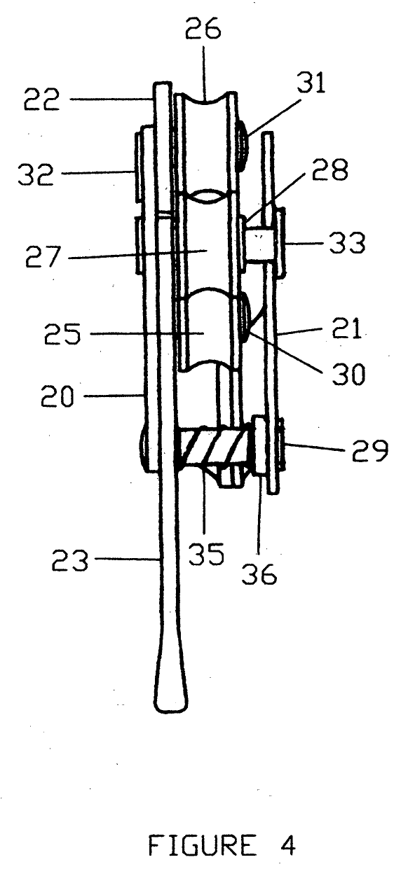

FIG. 4 shows the spring retainer 36 upon which the door rests. The door plate 21 has a connection point 24B that aligns with the connection point 24A on the base plate 20 when in use to secure the door plate 21 closed.

FIG. 2 shows a slot 37 in the door plate 21 that fits under the head of the stationary pulley stud 33 to aid in preventing the door plate 21 from being forced open by the rope 39. The slot 37 in the door plate 21 is opposite the door connection point 24B.

In FIG. 2, the pivoting plate 22 is mounted to the base plate 20. Being of an arcuate shape, it pivots about its connection parallel to the base plate 20. Secured to the pivoting plate 22 are two freely rotating pulleys. Pulleys 25 and 26 are secured to the pivoting plate 22 by studs 30 and 31. Pulley 26 is located slightly off the pivot point 32 of the pivoting plate 22. Pulley 25 is on the opposite end of the pivoting plate 22 from the connection point 32 to the base plate 20. The pivoting plate 22 makes an eccentric movement relative to a stationary pulley 27.

The stationary pulley 27 is mounted to the base plate 20 so as to be between the pivoting plate pulleys 25 and 26 when in use. The stationary pulley 27 also rotates freely about the stud that secures it to the base plate.

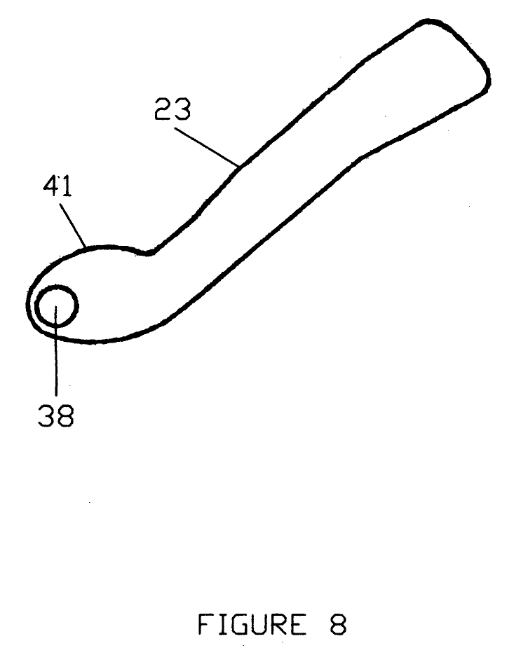

FIG. 8 shows the control handle 23 having a cam formed on one end with the opposite end being flat for gripping. The control handle 23 is mounted on the base plate 20 through a hole in the control handle 23 at the cam-shaped end. It is connected by the same stud 33 as the stationary pulley 27 (FIG. 2) where it is placed under the stationary pulley 27 and pivots about its connection as needed.

Pressure applied by moving the control handle 23 down makes contact between the cam surface 41 on the control handle 23 and the pivoting plate 22 in FIG. 2. This moves the pivoting plate 22 down, thereby widening the space between the two pulleys 25 and 26 mounted on the pivoting plate 22 and the stationary pulley 27 mounted on the base plate 20 and lessening the clamping effect of the pulleys on the rope 39. Descent speed is varied by the downward pressure on the control handle 23 which gradually releases the rope 39. Releasing the control handle 23 lets the pivoting plate 22 return to its locked position, stopping all rope movement.

FIG. 2 shows the speed regulator 34 pivotally mounted on the base plate 20 by the stud 29 that secures the door plate to the base plate so as to contact the control handle 23 when rotated into position.

The speed regulator 34 is of a flat design having a tab turned at a right angle that engages the base plate 20 to prevent over-rotation when in use. A compression spring 35 holds the speed regulator 34 in position. The speed regulator 34 is situated on the base plate 20 under the control handle's free end to limit full downward travel of the control handle 23, resulting in a maximum descent rate that is considerably less than the maximum achieved without the use of the speed regulator 34. When the speed regulator 34 is pivoted into slow-speed position, the control handle 23 can only depress the pivoting plate 22 to a predetermined point, thereby widening the gap between the two pulleys 25 and 26 that are mounted on the pivoting plate 22 and the stationary pulley 27 that is mounted on the base plate 20. The gap cannot increase beyond this point with the speed regulator 34 in position.

### Operation

When secured above, the rope 39 enters the descender around the outermost radius of pulley 25, then proceeds 180 degrees around the bottom of pulley 25 to between pulley 25 and the stationary pulley 27, then turns 180 degrees over the top of pulley 27 to between pulley 27 and pulley 26 where it exits as the loose end.

Due to the routing of the rope, pulley 25 is pulled upward when weight is suspended at the connection point 24A. The pulleys 25 and 26 are urged toward the pulley 27 because of the upward pull of the rope 39 and the eccentric movement of the pivoting plate 22. The rope 39 is caught between pulleys 25 and 26 and the stationary pulley 27 in a clamping action that stops all rope travel.

A control handle 23 having a cam surface 41 that contacts the pivoting plate 22 widens the gap between the stationary pulley 27 that is mounted on the base plate and the pulleys 25 and 26 mounted on the pivoting plate 22. The more the control handle 23 is moved downward, the greater the rate of descent. Releasing the control handle 23 results in the descender locking again.

The speed regulator 34 can be rotated into position when only a slow descent is needed. The speed regulator 34 stops the control handle 23 from full travel downward, resulting in less than the maximum rate of descent.

### CONCLUSION

Friction is very destructive to ropes used in abseiling. Depending upon the device used, there is a varying degree of wear, both on the rope and on the descender used. Some descenders have a relatively short life span due to the heat and wear caused by the friction of the rope sliding through the device which is the most common method used. This descender as described has very little friction due to the bearings in all of the pulleys. Without bearings, the rope slides through the descender creating excessive heat and wear.

Some descenders slip as weight increases. This descender only gets tighter, and, unlike other descenders that have jerky starts from a stopped position, this descender provides smooth starts. Descent rate is easily controlled, and with the speed regulator in position, only a low speed can be attained, making it safer than other descenders for novices or for use in tight situations.

This descender should wear very slowly due to the bearings, resulting in cost savings from less-frequent replacement of the descender or rope.

Friction-type descenders will slip when a wet rope is used, making them more dangerous when wet situations arise. This descender as described is not affected by water or oil because of the clamping of the rope rather than a reliance on friction.

This descender can be connected to a secure base and used to lower objects or persons. Its braking system decreases the possibility of dropping the object or person. It can also be suspended above and used as a stationary pulley to raise objects with a rope. This device may also be used as a trolley for traveling along a horizontal rope while suspended in a harness. This descender may not be limited solely to these uses.

The descender described can be made for double-rope use by using double-grooved pulleys or double pulleys in the locations of pulleys 25, 26, and 27.

This descender addresses the friction problem and eliminates it.

### DRAWINGS REFERENCE NUMERALS WORKSHEET

Part Name
20 BASE PLATE
21 DOOR PLATE
22 PIVOTING PLATE
23 CONTROL HANDLE
24A CONNECTION POINT
24B DOOR CONNECTION POINT
25 PULLEY
26 PULLEY
27 STATIONARY PULLEY
28 PULLEY RETAINER
29 DOOR STUD
30 PULLEY STUD
31 PULLEY STUD
32 PIVOTING PLATE STUD
33 STATIONARY PULLEY STUD
34 SPEED REGULATOR
35 SPEED REGULATOR SPRING
36 SPRING RETAINER
37 DOOR SLOT
38 CONTROL HANDLE CONNECTION POINT
39 ROPE
40A INDICATES BENDS IN DOOR
40B INDICATES BENDS IN BASE
41 CONTROL HANDLE CAM SURFACE

I claim:

1. A self-locking descender for abseiling along a rope comprising:
A base plate, having a means for connection to a harness,
A pivoting plate mounted on said base plate about an axis, pivoting parallel relative to said base plate, said pivoting plate having multiple projections mounted thereon,
A stud affixed on said base plate, at a predetermined distance from said pivoting plate axis,
A mechanism for increasing the space between said stud affixed to said base plate and said pivoting plate mounted to said base plate,

2. The projections in claim 1 are studs mounted on the pivoting plate with bearings installed thereon.

3. In claim 1, the mechanism for increasing the space between said stud affixed to said base plate and said pivoting plate mounted to said base plate rotates about its connection on said base plate. This mechanism has a cam design on the affixed end with the opposite end being in the form of a handle.

4. In claim 1, the stud affixed to said base plate has freely rotating bearings installed thereon.
